(19) United States
(12) Patent Application Publication
(10) Pub. No.: US 2025/0083836 A1
(43) Pub. Date: Mar. 13, 2025

(54) DEVICE AND METHOD FOR MOUNTING AND DISMANTLING COMPONENTS OF AN AIRCRAFT ENGINE

(71) Applicant: Lufthansa Technik AG, Hamburg (DE)

(72) Inventors: Kai Malte SCHERZINGER, Hamfelde (DE); Marcus WEDEMANN, Munster (DE); Sören SCHMIEDER, Quickborn (DE)

(21) Appl. No.: 18/830,704

(22) Filed: Sep. 11, 2024

(30) Foreign Application Priority Data
Sep. 12, 2023 (DE) 10 2023 124 522.8

(51) Int. Cl. B64F 5/40

(52) U.S. Cl. CPC B64F 5/40

(57) ABSTRACT

A device is capable of mounting and dismantling components of an aircraft engine. The device includes: a crossbar for connecting to a lifting apparatus; a main strut extending from the crossbar; and a cross-member adjoining a free end of the main strut at an angle. The cross-member is formed at the free end and configured for connecting adapters, retaining members, or components of the aircraft engine. The main strut is formed in two parts, with an articulation arranged between the two parts in such a way that the cross-member is moveable toward the crossbar when the articulation is actuated starting from an extended state thereof.

### CROSS REFERENCE TO RELATED APPLICATIONS

This application claims benefit to German Patent Application No. DE 10 2023 124 522.8, filed on Sep. 12, 2023, which is hereby incorporated by reference herein.

### FIELD

The present disclosure relates to a device and to a method for mounting and dismantling components of an aircraft engine.

### BACKGROUND

Between regularly provided major revisions to an aircraft engine—in which the engine is disassembled almost completely, and each component is inspected for damage and repaired or replaced as required—it can be necessary to replace individual engine components early due to damage. In this case, to replace various components of an engine, specific dismantling and mounting procedures are defined, which make it possible to replace the affected components as quickly as possible. In order to carry out these procedures, special tools and/or other aids can also be provided or required. It is also specified whether the engine can remain on the wing of the aircraft (“on-wing”) for a corresponding component replacement, or whether the component replacement has to take place when the engine is separated from the aircraft in a workshop qualified for this purpose (“in-shop”).

For example, a procedure for replacing the transmission system of the first airfoil stage of an aircraft engine (“fan drive gear system”, FDGS) is known, for which it is specified that the engine must be located in a workshop, separated from the aircraft. After removing the engine casing, in particular in the region of the engine inlet, a plurality of components, generally at least the airfoil hub, a bearing housing and at least one bearing, must be removed one after the other before the transmission system to be replaced can be removed. Subsequently, the above-mentioned components have to be remounted in a different order, in which all the defective components can be replaced with corresponding replacement parts.

For the above-mentioned procedure, special tools and aids are provided which are designed for use in suitably equipped workshops, thus for workshops for engine overhauls, which have inter alia holders for holding engines when they are separated from the aircraft.

The disadvantage of this procedure is that, in order to replace a transmission system for the first airfoil stage of an aircraft engine, firstly the engine per se has to be dismantled, which regularly leads to a considerable immobilization time for the aircraft.

### SUMMARY

In an embodiment, the present disclosure provides a device that is capable of mounting and dismantling components of an aircraft engine. The device includes: a crossbar for connecting to a lifting apparatus; a main strut extending from the crossbar; and a cross-member adjoining a free end of the main strut at an angle. The cross-member is formed at the free end and configured for connecting adapters, retaining members, or components of the aircraft engine. The main strut is formed in two parts, with an articulation arranged between the two parts in such a way that the cross-member is moveable toward the crossbar when the articulation is actuated starting from an extended state thereof.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a first exemplary embodiment of a device according to the present disclosure, in the ready-to-use state; and

FIG. 2 is a schematic view of the device from FIG. 1 in the folded-up state.

### DETAILED DESCRIPTION

Aspects of the present disclosure provide an option in which the disadvantages from the prior art no longer arise, or arise to only a reduced extent.

Accordingly, the present disclosure relates to a device for mounting and dismantling components of an engine, comprising a crossbar for connecting to a lifting apparatus, a main strut extending from the crossbar, and a cross-member adjoining the free end of the main strut at an angle, which cross-member is formed at the free end thereof for connecting adapters, retaining members or components of an aircraft engine, wherein the main strut is formed in two parts with an articulation arranged between the two parts in such a way that the cross-member can be moved toward the crossbar when the articulation is actuated.

Furthermore, the present disclosure relates to a method for mounting and dismantling components of an aircraft engine, wherein, in order to mount and dismantle at least one component, a device according to the present disclosure is used in the extended state of the articulation of the main strut, and the aircraft engine is located on the wing of an aircraft.

The present disclosure has found that a procedure for replacing, for example, a transmission system for the first airfoil stage of an aircraft engine (as is known in principle) can also be carried out when the aircraft engine is mounted on the aircraft and/or when the engine casing is mounted. At the same time, the present inventors have also found that, for this purpose, the known special tools and aids have to be dimensioned differently in part, wherein a corresponding re-dimensioning of at least one part of the aids would greatly reduce the handleability thereof in such a way that it would hardly provide an advantage over carrying out the known procedure. In this case, the handleability of the aids also refers in particular to the transportation thereof to a place of use. If the aids are also easy to handle for transportation purposes, they do not have to be kept at every conceivable point of use, but rather can be transported quickly to any point of use as required.

In order to ensure the described handleability in the case of the device according to the present disclosure, it is provided to divide the main strut extending between the crossbar and the cross-member into two parts by means of an articulation in such a way that the cross-member can be moved toward the crossbar as required by actuating the articulation. By providing an articulation of this type, greatly reduced packing dimensions can be achieved by comparison with the completely unfolded state, in which the device is suitably formed and configured for carrying out the desired procedure, and these reduced packing dimensions significantly facilitate not only the actual transportation of the device, but also the handling thereof in preparation for carrying out the desired procedure.

In the case of the device, it is particularly preferable for the articulation for the completely extended state—that is to say the state which is provided for carrying out the procedure and in which the cross-member is located in the desired end position during a movement away from the crossbar—to have a stop. By means of such a stop, it can be ensured that the loads occurring in the main strut during the use of the device according to the specified procedure can be dissipated at least in part directly via the stop. Moreover, by means of such a stop, it can be ensured that, at least in the case of a non-positive fit, the articulation can no longer be moved over the stop, and thus the main strut is dimensionally stable.

It is preferable for the axis of the articulation to extend perpendicularly to at least two, preferably to all of the longitudinal axes of the main strut, the crossbar and/or the cross-member. By means of a corresponding arrangement of the articulation axis, it is generally ensured that the pivoting movement made possible by the articulation takes place in or parallel to a plane in which at least two of the components out of the main strut, the crossbar and the cross-member lie, so that the extent of the device perpendicular to this plane remains virtually unchanged as a result of an actuation of the articulation.

Preferably, the articulation is formed so as to be secured in the completely extended and/or completely folded-up state. It is thereby ensured that, after being secured, the articulation can no longer inadvertently move away out of one of the above-mentioned end positions. For securing purposes, a securing element acting in an interlocking manner can be provided. By way of example, a securing pin can be guided through suitable openings in the articulation and/or at least one of the two parts of the main strut.

Because the device according to the present disclosure can be folded up due to the provided articulation, whereby the packing dimensions of the device can be reduced to a size which is easier to handle by comparison with the unfolded state, the crossbar, the main strut and the cross-member are preferably dimensioned in such a way that, when using the device, the cross-member or an adapter connected thereto can be connected to components arranged on the engine axis of an aircraft engine or retaining members fixed to the components without the cladding of the engine or even only parts thereof having to be removed. Even if a correspondingly re-dimensioned device known from the prior art would be virtually impossible to handle due to the resulting size, in the case of the device according to the present disclosure, the handleability is provided by the articulation provided on the main strut.

In order to ensure that, when in use, the device occupies or maintains a desired position with respect to the horizontal regardless of the adapter optionally connected to the device or components fixed to the device or an adapter, it is preferable, for connecting to a lifting apparatus, for a carriage which is displaceable along the crossbar to be provided with a connection point for a lifting apparatus. By means of a suitable displacement of the carriage, torques produced as a result of masses suspended on the device can be compensated, and a desired position of the device with respect to the horizontal can be achieved.

In order to ensure that a position with respect to the horizontal is maintained once set, but also in order to be able to change this position in a safe and precise manner as required during the use of the device, it is also preferable for a self-locking mechanism to be provided to displace the carriage along the crossbar. For this purpose, the mechanism can comprise for example a threaded spindle, which can still be rotated in a controlled manner even when using the device. For this purpose, the threaded spindle can be actuated directly, that is to say directly along the axis of the threaded spindle. However, an angle gear can also be provided, by means of which the actuation of the threaded spindle or another mechanism can also be actuated about another axis which may be more ergonomically suitable. The angle gear can also be configured to be self-locking, for example in the form of a worm gear.

In order to explain the method according to the present disclosure, reference is made to the preceding embodiments, in which the proper use of the device can already be found: The device is connected by the crossbar thereof to a lifting apparatus and thus guided onto the component to be mounted or dismantled in such a way that it can be connected at the free end of the cross-member optionally with the aid of adapters to the lifting apparatus or to these provided retaining members. If a corresponding connection has taken place, the component can be moved toward or away from the aircraft engine for mounting or dismantling.

The component mounted or dismantled with the aid of the device can be in particular a transmission system for the first airfoil stage of the aircraft engine, the airfoil hub, a bearing housing and/or a bearing.

The present disclosure will now be described by way of example on the basis of a preferred exemplary embodiment, with reference to the accompanying drawings.

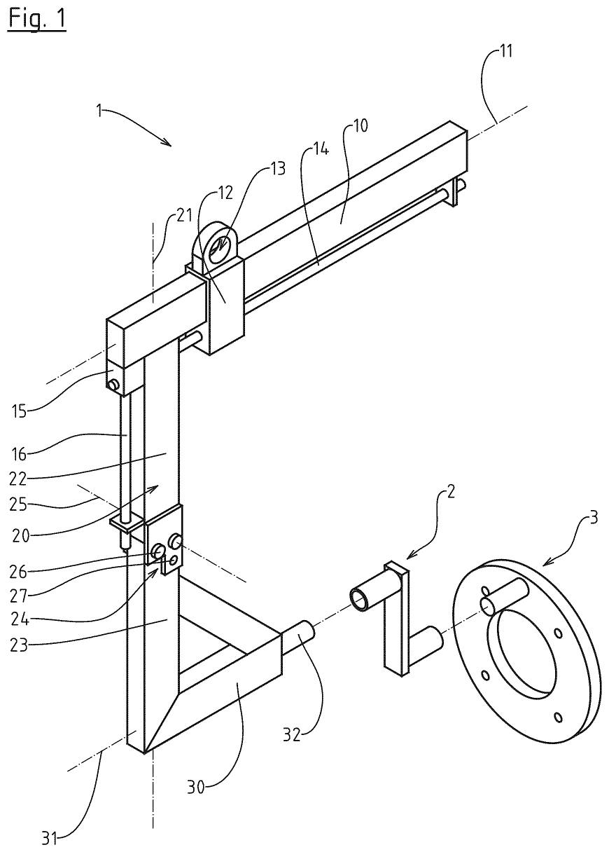

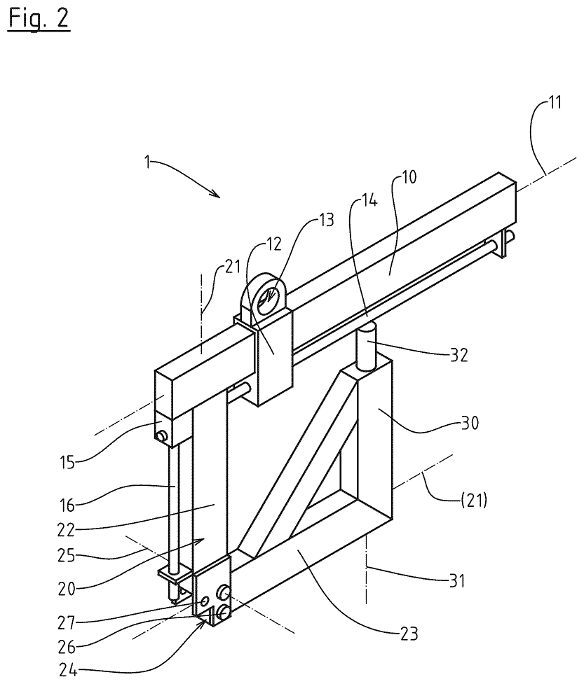

FIGS. 1 and 2 are schematic views of a device 1 according to an embodiment of the present disclosure for mounting and dismantling components of an aircraft engine.

The device 1 comprises a crossbar 10, a main strut 20 extending perpendicularly therefrom, and a cross-member 30 connected to the free end of the main strut 20. The longitudinal axes 11, 21, 31 of the crossbar 10, the main strut 20 and the cross-member 30 lie in the same plane. In the ready-to-use state of the device shown in FIG. 1, the longitudinal axes 11, 31 of the crossbar 10 and the cross-member 30 are parallel.

On the crossbar 10, a carriage 12 which is displaceable along the crossbar 10 is arranged. On the carriage 12, an eyelet 13 for connecting the device 1 to a lifting apparatus is provided. The carriage 12 can move along the crossbar 10 via the threaded spindle 14. By means of the threaded spindle 14, a self-locking mechanism for displacing the carriage 12 is ensured, since although the carriage 12 moves during rotation of the threaded spindle 14, another force acting on the carriage 12 in the direction of the longitudinal axis 11 of the crossbar 10 does not result in any movement of the carriage 12.

The threaded spindle 14 is connected to an actuating shaft 16 via an angle gear 15, which shaft can be easily reached even when using the device 1. If for example a crank is connected at the free end of the actuating shaft 16, the carriage 12 can still be displaced along the crossbar 10 even when using the device 1.

At the free end of the cross-member 30, a pin 32 protruding out of the cross-member 30 and rigidly connected thereto is provided, to which pin adapters 2 designed for this purpose can be connected. The adapters 2 can be connected to retaining members 3 on the other side, which retaining members can be fixed to the components to be removed or mounted. However, it is also possible for an adapter 2 to be connected directly to a component to be removed or mounted, or for the retaining member 3 to be connected directly to the cross-member 20. Likewise, in the case of a suitable configuration of the component to be mounted or removed, it is possible for this component to be connected to the cross-member 30 or the pin 32 directly and in particular without an adapter 2 or retaining members 3.

The main strut 20 of the device 1 is configured in two parts, wherein the two parts 22, 23 of the main strut 20 can be pivoted relative to one another by means of an articulation 24 arranged between the two. In this case, the pivot axis 25 of the articulation 24 extends perpendicularly to the longitudinal axes 11, 21, 31 of the crossbar 10, the main strut 20 (or the two parts 22, 23 thereof) and the cross-member 30.

The articulation 24 is configured in such a way that the end faces of the two parts 22, 23 of the main strut 20 lie edge-to-edge with one another in the completely extended state of the articulation 24, as shown in FIG. 1. The articulation 24 thus comprises a stop for the completely extended state, by means of which, in particular in the loaded state of the device 1, i.e. in a state in which a component 30 is suspended on the cross-member 30, a considerable flux of force takes place.

In particular, the securing element 26 provided to secure the main strut 20 in the extended state, which element is guided through suitable openings 27 and the second part 23 of the main strut 20, in order to produce a form of closure, only has to transmit little to no force in the loaded state of the device 1 as a result of the described stop.

The securing element 26 can also be used to secure the articulation 24 in the folded-up state shown in FIG. 2.

In order to move the articulation 24 from the state shown in FIG. 1 to that shown in FIG. 2, the securing element 26 is firstly removed, the cross-member 30 is moved toward the crossbar 10, and the securing element 24 is subsequently inserted back into the suitable openings 27 and the second part 23 of the main strut 20.

The crossbar 10, the main strut 20 and the cross-member 30 are dimensioned in such a way that the device 1 can be connected to components of an aircraft engine arranged on the engine axis with or without adapters 2 and/or retaining members 3 without the casing of the engine or even only parts thereof having to be removed for this purpose. As a result, in the state suitable for the corresponding use, as shown in FIG. 1, the device 1 has an extent which does allow handling of the device 1 in a state in which it is carried by a lifting apparatus. However, if the device 1 is not suspended on a lifting apparatus, the dimensions of the device in the state according to FIG. 1 are such that good handleability cannot be assumed.

However, the good handleability is achieved in that the device 1 is transferred from the state shown in FIG. 1 into that from FIG. 2. If, in the state shown in FIG. 1, the crossbar 10 and the main strut 20 have for example a length of approximately 2 m or approximately 1.9 m, resulting in packing dimensions of 2 m×1.9 m×0.1 m, the packing dimensions can be reduced to approximately 2 m×1.2 m×0.1 m by using the articulation, which is much easier to handle.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A device for mounting and dismantling components of an aircraft engine, the device comprising:
a crossbar configured to connect to a lifting apparatus;
a main strut extending from the crossbar; and
a cross-member adjoining a free end of the main strut at an angle, the cross-member being formed at the free end thereof and configured for connecting adapters, retaining members, or components of the aircraft engine,
wherein the main strut is formed in two parts, with an articulation arranged between the two parts in such a way that the cross-member is moveable toward the crossbar in a condition where the articulation is actuated starting from an extended state thereof.

2. The device as claimed in claim 1, wherein the articulation comprises a stop configured for the completely extended state.

3. The device as claimed in claim 1, wherein an axis of the articulation extends perpendicularly to at least two of a plurality of longitudinal axes of the crossbar, the main strut, or the cross-member.

4. The device as claimed in claim 1, wherein the articulation is formed so as to be secured in the completely extended state and a completely folded-up state.

5. The device as claimed in claim 1, wherein the crossbar, the main strut, and the cross-member are dimensioned in such a way that, when using the device, the cross-member or an adapter connected thereto is configured to be connected to components arranged on the engine axis or retaining members fixed to the components without the casing of the aircraft engine or parts thereof having to be removed.

6. The device as claimed in claim 1, the device further comprising a carriage, which is displaceable along the crossbar and comprises a connection point configured to connect to the lifting apparatus.

7. The device as claimed in claim 6, the device further comprising a self-locking mechanism for displacing the carriage along the crossbar.

8. The device as claimed in claim 7, wherein the self-locking mechanism comprises a threaded spindle or an angle gear.

9. A method for mounting and dismantling the components of the aircraft engine, the method comprising: in order to mount and dismantle at least one component, the device as claimed in claim 1 is used in the extended state of the articulation of the main strut, and the aircraft engine is located on the wing of an aircraft.

10. A method for mounting and dismantling the components of the aircraft engine, the method comprising: mounting or dismantling a component of a transmission system for a first airfoil stage of the aircraft engine, using the device of claim 1, the component being the airfoil hub, a bearing housing, or a bearing.
